(19) United States
(12) Patent Application Publication
(10) Pub. No.: US 2018/0357338 A1
(43) Pub. Date: Dec. 13, 2018

(54) KINEMATICS TABLE GENERATION FOR STEERING HARDWARE SIMULATOR

(71) Applicant: GM GLOBAL TECHNOLOGY OPERATIONS LLC, Detroit, MI (US)

(72) Inventors: Nathan M. Picot, Farmington Hills, MI (US); Aaron Ronald, White Lake, MI (US); Jarred Versical, Commerce Township, MI (US)

(73) Assignee: GM GLOBAL TECHNOLOGY OPERATIONS LLC, Detroit, MI (US)

(21) Appl. No.: 15/621,684

(22) Filed: Jun. 13, 2017

(51) Int. Cl. G06F 17/50

(52) U.S. Cl. CPC G06F 17/5009; G06F 2217/16

(57) ABSTRACT

A method of simulating movement of a suspension system that moves with six degrees of freedom, with a test simulator that moves with two degrees of freedom, includes converting an effective two degree of freedom road wheel angle at a wheel end of the test simulator into a simulated six degree of freedom road wheel angle. A six degree of freedom kingpin moment is defined. A two degree of freedom tie rod input force is calculated from the six degree of freedom kingpin moment and an effective steer arm length. The two degree of freedom tie rod input force is applied to the test simulator to generate torque feedback in the test simulator.

### INTRODUCTION

The disclosure generally relates to a method of simulating movement of a vehicle suspension system with a test simulator. More specifically, the method relates to simulating movement of the vehicle suspension system, which moves with a fixed number of degrees of freedom, e.g., six degrees of freedom, with the test simulator that moves with less than the fixed number of degrees of freedom, e.g., only two degrees of freedom.

A vehicle may be equipped with an electric power steering system. The electric power steering system uses an electric motor to assist the driver of the vehicle in turning the steering wheels of the vehicle. Sensors detect the position and torque of the steering column and/or steering wheel, as well as the current operating conditions of the vehicle, and a steering controller applies an assistive torque via the motor, to decrease the amount of torque that the driver must apply to turn the steering wheel, and thereby turn the steering wheels of the vehicle.

The amount of assistive torque that the steering controller controls the motor to apply varies with the operating conditions of the vehicle. The vehicle controller may reference a calibration table that relates various operating conditions of the vehicle to a desired assistive torque. The calibration table is stored in an electronic memory of the steering controller. The calibration table must be defined to provide a desirable amount of assistive torque for the various operating conditions of the vehicle. If the amount of assistive torque is too low, the steering wheel will require a higher level of torque from the driver to turn, which may be undesirable to some drivers. Alternatively, if the assistive torque is too high, the steering wheel may turn too freely, which may also be undesirable for some drivers. Defining the values for the assistive torque in the calibration table may be referred to as tuning the calibration table, and is typically done during vehicle development.

Electric power steering systems are difficult to model electronically. Accordingly, in the past, tuning the calibration table for electric power steering systems has been done by installing the electric power steering system on a prototype vehicle, test driving the prototype vehicle with a defined calibration table, and then adjusting the calibration table based on the subjective feel observed by the test driver of the prototype vehicle.

Alternatively, the suspension and steering components of the vehicle may be mounted onto an actuator machine, which manipulates the suspension and steering components to simulate driving conditions, thereby enabling the tuning of the calibration table. Since the suspension system of a vehicle moves with a fixed number of degrees of freedom, typically six degrees of freedom, this approach requires that the actuator machine be capable of moving the suspension and steering components with the same six degrees of freedom, which requires a very complex machine. This approach requires that the suspension and steering components for that specific vehicle be mounted to the actuator machine. This precludes tuning the calibration table when the suspension and steering system of the vehicle are in their initial design phases, and have not yet been designed and/or produced.

### SUMMARY

A method of simulating movement of a vehicle suspension system with a test simulator is provided. The vehicle suspension system moves with a fixed number of degrees of freedom. The test simulator moves with less than the fixed number of degrees of freedom. The method includes applying a steering input to the test simulator to generate an effective road wheel angle at a wheel end of the test simulator. The effective road wheel angle is based on the less than the fixed number of degrees of freedom of the test simulator. The effective road wheel angle of the test simulator is converted to a simulated road wheel angle, with a conversion algorithm. The simulated road wheel angle is based on the fixed number of degrees of freedom of the suspension system. An effective steer arm length is calculated with the conversion algorithm. A simulated kingpin moment is calculated as a function of the simulated road wheel angle with a vehicle dynamics mathematical model. The simulated kingpin moment is based on the fixed number of degrees of freedom of the suspension system. A tie rod input force for the test simulator is then calculated from the effective steer arm length and the simulated kingpin moment, with a force calculation algorithm. The calculated tie rod input force is applied to the test simulator. An effective handwheel torque feedback in the test simulator is sensed in response to the applied tie rod force.

In one embodiment of the method, the fixed number of degrees of freedom of the suspension system includes six degrees of freedom. The six degrees of freedom of the suspension system may be defined as axial displacement along an X-axis, a Y-axis, and a Z-axis of a Cartesian coordinate system, and rotation about the X-axis, the Y-axis and the Z-axis of the Cartesian coordinate system.

In one embodiment of the method, the less than the fixed number of degrees of freedom of the test simulator includes two degrees of freedom. The two degrees of freedom of the test simulator may be defined as axial displacement along the Z-axis, and rotation about the Z-axis.

One aspect of the method of simulating movement of the vehicle suspension system includes selecting the steering input with a vehicle simulator.

In one embodiment of the method, the step of applying the tie rod input force to the test simulator includes engaging an actuator to apply the tie rod input force.

One aspect of the method of simulating movement of the vehicle suspension system includes defining the conversion algorithm to relate the fixed number of degrees of freedom of the vehicle suspension system to the less than the fixed number of degrees of freedom of the test simulator. Another aspect of the method of simulating movement of the vehicle suspension system includes defining the conversion algorithm to calculate an effective steer arm length for the simulated vehicle given the position of the vehicle suspension system.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a test simulator connected to a test controller.

FIG. 2 is a flowchart representing a method of simulating movement of a vehicle suspension system using the test simulator and the test controller.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

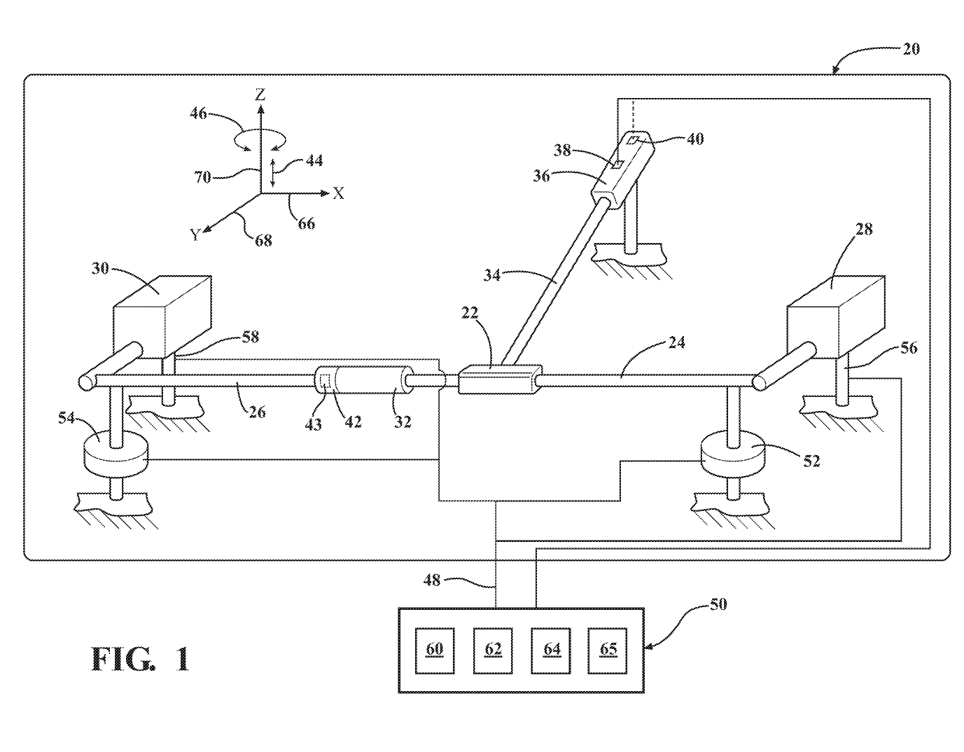

Referring to the FIGS., wherein like numerals indicate like parts throughout the several views, a test simulator is generally shown at 20 in FIG. 1. Referring to FIG. 1, the test simulator 20 includes a steering rack 22 coupled to a left tie rod 24 and a right tie rod 26. The left tie rod 24 is attached to a left wheel end 28, and the right tie rod 26 is attached to a right wheel end 30. An electric motor 32 is connected to the steering rack 22, and is operable to apply a variable amount of torque to the steering rack 22. The torque applied to the steering rack 22 may be referred to as assist torque. The exemplary embodiment of the test simulator 20 includes an intermediate shaft 34 that is attached to the steering rack 22, and connects the steering rack 22 with a steer actuator 36. While the exemplary embodiment of the test simulator 20 is shown with the intermediate shaft 34 connecting the steering rack 22 and the steer actuator 36, it should be appreciated that the steering rack 22 may alternatively be controlled by a “control-by-wire” system as understood by those skilled in the art. The steer actuator 36 includes a torque sensor 38, and a steering angle sensor 40. The torque sensor 38 is operable to sense steer torque feedback in the intermediate shaft 34. The steering angle sensor 40 is operable to sense and/or determine an angular position of the intermediate shaft 34, and is used for inputting a steering angle to the intermediate shaft 34.

A steering controller 42 is connected to the electric motor 32, preferably as a single unit. The steering controller 42 may include a control module or a computer that is operable to control the operation of the electric power steering system. The steering controller 42 may include a processor, and all software, hardware, memory, algorithms, connections, sensors, etc., necessary to manage and control the operation of the electric power steering system. It should be appreciated that the steering controller 42 may include any device capable of analyzing data from various sensors, comparing data, making the necessary decisions required to control the operation of the electric power steering system, and executing the required tasks necessary to control the operation of the electric power steering system.

The steering controller 42 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The steering controller 42 includes tangible, non-transitory memory on which are recorded computer-executable instructions, including a steering assist selection algorithm 43. The processor of the steering controller 42 is configured for executing the steering assist selection algorithm 43. The steering assist selection algorithm 43 implements a method of selecting a value for a steering setting to be applied to steering rack 22. The steering setting may include or otherwise be defined as the assist torque. The steering assist selection algorithm 43 references a calibration table to define a value of the steering setting, based on defined inputs, i.e., defined operating conditions.

Accordingly, the calibration table may be stored in a memory device of the steering controller 42 in the form of a data file or the like.

The test simulator 20 is operable or configured to move with a reduced capability relative to an actual suspension system of a vehicle. More specifically, the test simulator 20 is configured to move with fewer degrees of freedom than the typical six degrees of freedom that a vehicle suspension system moves in. In the exemplary embodiment shown in the Figures and described herein, the test simulator 20 moves with two degrees of freedom. However, it should be appreciated that the test simulator 20 may be configured to move with any number of degrees of freedom that is less than the actual number of degrees of freedom of the vehicle suspension system, e.g., the typical six degrees of freedom in which most vehicle suspension systems move in. Since the test simulator 20 shown in the Figures is configured to simulate movement of both the left wheel end 28 and the right wheel end 30, it should be appreciated that each of the left wheel end 28 and the right wheel end 30 moves with the two degrees of freedom. The two degrees of freedom for each wheel end of the test simulator 20 may include axial displacement along a Z-axis 70 of a Cartesian coordinate system, generally indicated by double ended arrow 44, and rotation about the Z-axis 70, generally indicated by double ended arrow 46. The Z-axis 70 of each respective wheel end is oriented in a generally vertical orientation, such that the axial displacement along the Z-axis 70 may be considered or referred to as jounce, rebound, or vertical movement. Since the test simulator 20 moves with fewer degrees of freedom than the actual suspension system of the vehicle, the rotation of the wheel ends 28, 30 about their respective Z-axes 70 does not exactly simulate an actual road wheel angle. However, with reference to the test simulator 20, the rotation of the wheel ends 28, 30 about their respective Z-axes 70 may be referred to or considered as an estimated road wheel angle.

The test simulator 20 is operable to apply input forces to the left tie rod 24 and the right tie rod 26 respectively, in response to a control input 48 from a test controller 50, in order to simulate movement of a vehicle suspension system. One embodiment of the test simulator 20 includes a plurality of hydraulic actuators. The hydraulic actuators may include a tie rod actuator and a jounce actuator for each wheel end. The hydraulic actuators are operable to move the test simulator 20 in its respective two degrees of freedom. Accordingly, the test simulator 20 may include a left tie rod actuator 52 for rotating a left wheel end 28 about its respective Z-axis 70, and a left jounce actuator 56 for moving the left wheel end 28 axially along its respective Z-axis 70. Similarly, the test simulator 20 may include a right tie rod actuator 54 for rotating a right wheel end 30 about its respective Z-axis 70, and a right jounce actuator 58 for moving the right wheel end 30 axially along its respective Z-axis 70. The control inputs 48 may include, for example, a steer angle input by the steer actuator 36, a tie rod force input by the right tie rod actuator 54 and the left tie rod actuator 52 respectively, and/or a jounce input from the left jounce actuator 56 and/or the right jounce actuator 58 respectively. The test simulator 20 is operable to sense a resultant estimated road wheel angle in response to the applied input forces, as well as sense a resultant torque feedback at the intermediate shaft 34 with the torque sensor 38, in response to the applied input forces.

The test controller 50 is disposed in electrical communication with the test simulator 20. The test controller 50 is operable to communicate the control inputs 48 to the test simulator 20, and receive the resultant estimated road wheel angle and the torque feedback at the intermediate shaft 34 from the test simulator 20. The test controller 50 and the test simulator 20 may communicate in any suitable manner, such as through a high speed communication protocol.

The test controller 50 may include a computer or other similar device that is operable to control the operation of the test simulator 20. The test controller 50 may include a processor, and include all software, hardware, memory, algorithms, connections, sensors, CAN communication modules, etc., necessary to manage and control the operation of the test simulator 20. As such, a method simulating movement of a vehicle suspension system having six degrees of freedom, with the test simulator 20, described below, may be at least partially embodied as a program operable on the test controller 50. It should be appreciated that the test controller 50 may include any device capable of analyzing data from various sensors, comparing data, making the necessary decisions required to control the operation of the test simulator 20, and executing the required tasks necessary to control the operation of the test simulator 20.

The test controller 50 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The test controller 50 may include tangible, non-transitory memory on which are recorded computer-executable instructions, including but not limited to a vehicle simulator algorithm 60, a vehicle dynamics mathematical model 62, a conversion algorithm 64, and a force calculation algorithm 65. The processor of the test controller 50 is configured for executing the vehicle simulator algorithm 60, the vehicle dynamics mathematical model 62, the conversion algorithm 64, and the force calculation algorithm 65.

The vehicle dynamics mathematical model 62 is a mathematic model of the specific vehicle that the calibration table is to be tuned for. The vehicle dynamics mathematical model 62 describes the physical configuration and operating characteristics of that specific vehicle, including the specifics of the vehicle suspension system that is to be simulated with the test simulator 20. The vehicle dynamics mathematical model 62 may be saved as a program or set of data files in the memory of the test controller 50. The vehicle dynamics mathematical model 62 describes the vehicle mass and loads, vehicle kinematics and compliance, center of gravity, tire characteristics, vehicle alignment and geometry, etc. The vehicle dynamics mathematical model 62 may describe any physical attribute of the vehicle being simulated, whether specifically mentioned herein or not.

The vehicle simulator algorithm 60 simulates the operation of one or more control modules of the specific vehicle to which the calibration table is to be tuned to. Accordingly, the vehicle simulator algorithm 60 must be programmed for each specific vehicle. The vehicle simulator algorithm 60 references and/or interacts with the vehicle dynamics mathematical model 62 in order to generate the control inputs 48 used to control the test simulator 20 to simulate the movement and operation of that specific vehicle. It should be appreciated that the control inputs 48 may include more than a single command, and will typically include multiple commands, such as but not limited to, a steering angle, a left side tie rod force, and/or a right side tie rod force, a left jounce force and/or a right jounce force. The vehicle simulator algorithm 60 houses all input/output signals and communications protocols between real and virtual control units. The control inputs 48 provided by the vehicle simulator algorithm 60 describe movement of the vehicle suspension system in the fixed number of degrees of freedom. Assuming the vehicle suspension system moves with six degrees of freedom, then the control inputs 48 from the vehicle simulator describe movement of the vehicle suspension system with six degrees of freedom. It should be appreciated that each wheel end of the vehicle suspension system may move with the exemplary six degrees of freedom. The exemplary six degrees of freedom for each wheel end of the vehicle suspension system may include axial displacement along a respective X-axis 66, a Y-axis 68, and the Z-axis 70 of a Cartesian coordinate system, and rotation about the respective X-axis 66, the Y-axis 68 and the Z-axis 70 of the Cartesian coordinate system.

In order to accurately simulate the operation of the vehicle suspension system, the control inputs 48 from the vehicle simulator algorithm 60, which are based on and simulate movement of the respective wheel ends with the fixed number of degrees of freedom, e.g., the exemplary six degrees of freedom, must be converted into control inputs 48 for the left wheel end 28 and the right wheel end 30 of the test simulator 20, which are based on the reduced number of degrees of freedom that each respective wheel end of the test simulator 20 moves in. While the detailed description below refers to the two degrees of freedom of the test simulator 20 and the six degrees of freedom of the vehicle suspension system, it should be appreciated that the degrees of freedom are for each wheel end. Accordingly, the two degrees of freedom of the test simulator 20 refers to the two degrees of freedom for each respective wheel end of the test simulator 20, and the six degrees of freedom of the vehicle suspension system refers to the six degrees of freedom for each respective wheel of the vehicle suspension system. Furthermore, as noted above, the exemplary embodiment of the test simulator 20 moves in two degrees of freedom. However, in other embodiments, the test simulator 20 may move with any number of degrees of freedom less than the six degrees of freedom that the vehicle suspension system moves in, e.g., 3, 4, or 5 degrees of freedom. Similarly, the exemplary embodiment of the vehicle suspension system moves in six degrees of freedom. However, in other embodiments, the vehicle suspension system may move with some other number of degrees of freedom.

The conversion algorithm 64 converts the control inputs 48 from the vehicle simulator algorithm 60, which simulates movement of the vehicle suspension system in the six degrees of freedom, into control inputs 48 for the test simulator 20, which simulates movement of the vehicle suspension system in the two degrees of movement. In order to do this, the conversion algorithm 64 must first be defined to relate the six degrees of freedom of the vehicle suspension system to the two degrees of freedom of the test simulator 20. The conversion algorithm 64 is specific to the specific vehicle suspension system being modeled by the vehicle simulator algorithm 60. The conversion algorithm 64 relates the motion of the outer tie rods of the vehicle suspension system, in a vehicle coordinate system, with the motion of the left tie rod 24 and right tie rod 26 in the test simulator 20 for the full range of jounce/rebound and steering angle input for the test simulator 20.

Because test simulator 20 has a completely vertical rotation and displacement axis, the tie rods in the actual suspension system move differently through space than do the left tie rod 24 and the right tie rod 26 of the test simulator 20. This creates a difference in simulated versus vehicle road wheel angle that should be accounted for. On the test simulator 20, the outboard connecting point of the left tie rod 24 and the outboard connecting point of the right tie rod 26 only displace along Z-axis 68 according to jounce/rebound, and move along the X-axis and the Y-axis in a circular arc strictly as a function of the distance from the vertical simulator kingpin axis. A vehicle may have the tie rods move and rotate about the X-axis 66, the Y-axis 68, and the Z-axis 70, as a function of the suspension geometry. The inner point of the left tie rod 24 and the inner point of the right tie rod 26 in the test specimen can only translate along the rack housing of the test simulator 20, i.e., the linear displacement 44 along the X-axis 66, there is no difference in motion between the linear movement of the inner point of the left tie rod 24 and the inner point of the right tie rod 26 in the test simulator 20, compared to tie rods from the actual vehicle suspension. This allows a relationship between the simulator and vehicle to be developed

This difference in motion, between the left tie rod 24 and the right tie rod 26 of the test simulator 20 and the tie rods from the actual vehicle suspension is correlated to a steering rack translation for the test simulator 20, i.e., rotational movement 46 about the Z-axis 70. This steering rack translation may then be correlated to a vehicle-level road wheel angle, which varies for any given suspension and steering position. This produces an accurate estimated road wheel angle based on the mathematical position (i.e., rotation and translation) of the test simulator 20. This process assumes, for simplification, that the steering rack 22 of the test simulator 20 is infinitely stiff and only translates along its axis, rather than rolling and flexing perpendicular to its motion. Furthermore, this process assumes, for simplification, that the position variation along the vehicle Z-axis 70 of the outer tie rods due to gross motion of the knuckle (e.g., spin about the kingpin axis, roll of the knuckle, compliance, etc.) is ignored, but could be included for increased accuracy.

The estimated road wheel angle from the conversion algorithm 64 is fed into the vehicle dynamics mathematical model 62. The vehicle dynamics mathematical model 62 uses the estimated road wheel angle to calculate a kingpin moment as a function of the simulated road wheel angle. The conversion algorithm 64 further calculates an effective steer arm length for each wheel end of the test simulator 20, which is used by the vehicle dynamics mathematical model 62 to calculate the left tie rod force and the right tie rod force for the test simulator 20, based on the calculated kingpin moment. The left tie rod force and the right tie rod force are calculated by the force calculation algorithm 65. In order for the conversion algorithm 64 to calculate the effective steer arm length, a polynomial fit of vehicle steer rack displacement and the test simulator's 20 effective position/displacement is defined or formulated. The derivative of this polynomial fit is calculated, such that the effective steer arm length is known for any given position of the vehicle suspension. Finally, this is changed into a usable format for this process, such that vehicle suspension position, from the vehicle simulator, may be input, and the effect steer arm length is output. The effective steer arm length may then be used in combination with the kingpin moment, to calculate the left tie rod force and the right tie rod force for the test simulator 20, using the force calculation algorithm 65.

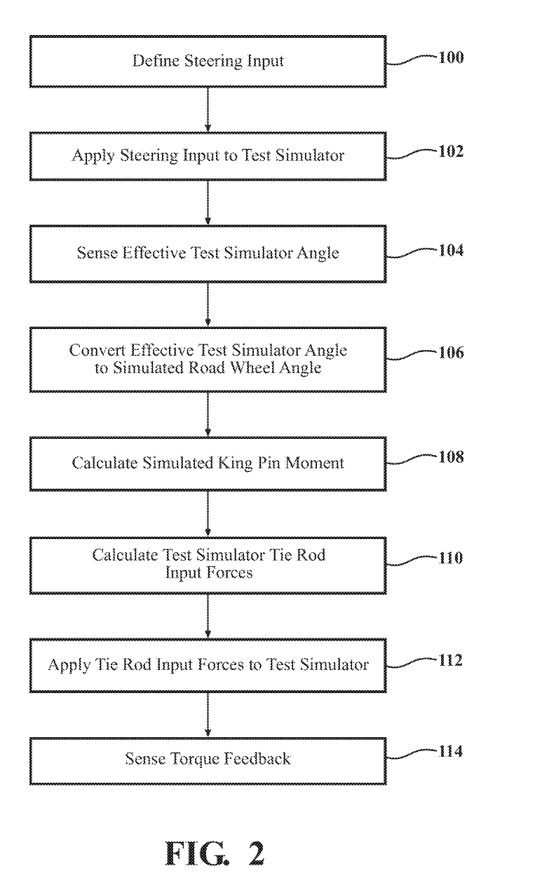

Referring to FIG. 2, the process of simulating movement of the vehicle suspension system with the test simulator 20 is described in greater detail below. Once the conversion algorithm 64 has been defined, the vehicle simulator may select or define a steering input. The step of defining the steering input is generally represented by box 100 in FIG. 2. The steering input is the control input 48 used to simulate the operation of the vehicle suspension system for a specific operating condition. As noted above, the steering input from the vehicle simulator described the movement of the vehicle suspension system in the six degrees of freedom. The steering input is applied to the test simulator 20, which generates an effective road wheel angle at the wheel ends 28, 30 of the test simulator 20. The step of applying the steering input to the test simulator 20 is generally represented by box 102 in FIG. 2. Because the test simulator 20 moves with the less than the fixed number of degrees of freedom, the effective road wheel angle is based on the less than the fixed number of degrees of freedom of the test simulator 20. Accordingly, in the exemplary embodiment described herein, the effective road wheel angle is based on the two degrees of freedom of the test simulator 20. The effective road wheel angle of the wheel ends 28, 30, obtained in response to the steering input, is sensed by the steering angle sensor 40. The step of sensing the effective test simulator 20 road wheel angle is generally represented by box 104 in FIG. 2.

The effective road wheel angle from the test simulator 20 is then converted into the simulated road wheel angle, with the conversion algorithm 64. The step of converting the effective test simulator road wheel angle to the simulated road wheel angle is generally represented by box 106 in FIG. 2. The simulated road wheel angle is based on the fixed number of degrees of freedom of the suspension system. Accordingly, in the exemplary embodiment, the simulated road wheel angle is based on the six degrees of freedom of the vehicle suspension system.

The simulated kingpin moment may then be calculated with the vehicle dynamics mathematical model 62. The step of calculating the simulated kingpin moment is generally represented by box 108 in FIG. 2. The simulated kingpin moment is based on the fixed number of degrees of freedom of the suspension system. Accordingly, for the exemplary embodiment, the simulated kingpin moment is based on the six degrees of freedom of the vehicle suspension system.

A tie rod input force for the test simulator 20, e.g., the left tie rod 24 input force or the right tie rod 26 input force, may then be calculated with the force calculation algorithm 65, using the effective steer arm length and the simulated kingpin moment. The step of calculating the tie rod input forces is generally indicated by box 110 in FIG. 2. The calculated tie rod input force may then be applied to the test simulator 20 with the tie rod actuators of the test simulator 20, as described above. The step of applying the calculated tie rod input forces to the test simulator is generally represented by box 112 in FIG. 2. The tie rod input force may be applied in any suitable manner. For example, one of the tie rod actuators may be engaged to apply the tie rod input force.

A position of the right wheel end 30 and the left wheel end 28 of the test simulator 20 may be sensed to identify any change in their respective positions, in response to the applied tie rod input forces. Additionally, the torque feedback in the intermediate shaft 34, in response to the applied tie rod input forces, may be sensed by the torque sensor 38. The step of sensing the torque feedback is generally represented by box 114 in FIG. 2.

This data conversion process may occur for each iteration of a real-time vehicle simulation. This allows for the full vehicle to be simulated for any type or combination of control inputs 48. This results in full real-time vehicle data that can be correlated to an actual vehicle. Further, this data may be used to make decisions on how the steering controller 42 should be tuned for performance, customer satisfaction needs, etc. The conversion algorithm 64 allows the data output from the reduced degree of freedom test simulator 20 to be significantly more similar to what a full vehicle suspension system would produce running the same tests. Thus, all results from the test simulator 20 are more directly applicable and give more quantitatively useful results.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of simulating movement of a vehicle suspension system having a fixed number of degrees of freedom with a test simulator having less than the fixed number of degrees of freedom, the method comprising:
applying a steering input to the test simulator to generate an effective road wheel angle at a wheel end of the test simulator, wherein the effective road wheel angle is based on the less than the fixed number of degrees of freedom of the test simulator;
converting the effective road wheel angle of the test simulator to a simulated road wheel angle, with a conversion algorithm, wherein the simulated road wheel angle is based on the fixed number of degrees of freedom of the suspension system;
calculating an effective steer arm length, with the conversion algorithm;
calculating a simulated kingpin moment as a function of the simulated road wheel angle, with a vehicle dynamics mathematical model, wherein the simulated kingpin moment is based on the fixed number of degrees of freedom of the suspension system;
calculating a tie rod input force for the test simulator from the effective steer arm length and the simulated kingpin moment, with a force calculation algorithm;
applying the calculated tie rod input force to the test simulator; and
sensing an effective handwheel torque feedback in the test simulator in response to the applied tie rod force.

2. The method set forth in claim 1, wherein the fixed number of degrees of freedom of the suspension system includes six degrees of freedom of the vehicle suspension system defined as axial displacement along an X-axis, a Y-axis, and a Z-axis of a Cartesian coordinate system, and rotation about the X-axis, the Y-axis and the Z-axis of the Cartesian coordinate system.

3. The method set forth in claim 2, wherein the less than the fixed number of degrees of freedom of the test simulator includes two degrees of freedom of the test simulator defined as axial displacement along the Z-axis, and rotation about the Z-axis.

4. The method set forth in claim 1, further comprising selecting the steering input with a vehicle simulator.

5. The method set forth in claim 1, wherein applying the tie rod input force to the test simulator includes engaging an actuator to apply the tie rod input force.

6. The method set forth in claim 1, further comprising defining the conversion algorithm to relate the fixed number of degrees of freedom of the vehicle suspension system to the less than the fixed number of degrees of freedom of the test simulator.

7. The method set forth in claim 1, further comprising defining the conversion algorithm to calculate an effective steer arm length for the simulated vehicle given a position of the vehicle suspension system.

8. A method of simulating movement of a vehicle suspension system having a six degrees of freedom with a test simulator having 2 degrees of freedom, the method comprising:
selecting the steering input with a vehicle simulator;
generating an effective road wheel angle based on the two degrees of freedom of the test simulator;
converting the effective road wheel angle to a simulated road wheel angle, with a conversion algorithm, wherein the simulated road wheel angle is based on the six degrees of freedom of the suspension system;
calculating an effective steer arm length, with the conversion algorithm;
calculating a simulated kingpin moment as a function of the simulated road wheel angle, with a vehicle dynamics mathematical model, wherein the simulated kingpin moment is based on the six degrees of freedom of the suspension system;
calculating a tie rod input force for the test simulator from the effective steer arm length and the simulated kingpin moment, with a force calculation algorithm;
applying the calculated tie rod input force to the test simulator; and
sensing an effective handwheel torque feedback in the test simulator in response to the applied tie rod force.

9. The method set forth in claim 8, wherein the six degrees of freedom of the suspension system are defined as axial displacement along an X-axis, a Y-axis, and a Z-axis of the vehicle suspension system, and rotation about the X-axis, the Y-axis and the Z-axis of the vehicle suspension system.

10. The method set forth in claim 9, wherein the two degrees of freedom of the test simulator are defined as axial displacement along the Z-axis, and rotation about the Z-axis.

11. The method set forth in claim 8, wherein applying the tie rod input force to the test simulator includes engaging an actuator to apply the tie rod input force.

12. The method set forth in claim 8, further comprising defining the conversion algorithm to relate the six degrees of freedom of the vehicle suspension system to the two degrees of freedom of the test simulator.

13. The method set forth in claim 8, further comprising defining the conversion algorithm to calculate an effective steer arm length for the simulated vehicle given a position of the vehicle suspension system.

14. A suspension simulation system for simulating movement of a vehicle suspension system that moves with a fixed number of degrees of freedom, the suspension simulation system comprising:
a test simulator having a wheel end that moves with less than the fixed number of degrees of freedom;
a test controller in communication with the test simulator, and having a processor and a memory having a vehicle simulator algorithm, a vehicle dynamics mathematical model, and a conversion algorithm, stored in the memory, with the processor operable to execute the vehicle simulator algorithm, the vehicle dynamics mathematical model, and the conversion algorithm;
wherein the vehicle simulator algorithm is operable to simulate operating conditions for the suspension system of the vehicle;
wherein the vehicle dynamics mathematical model is operable to model movement of the suspension system of the vehicle based on the simulated operating conditions provided by the vehicle simulator algorithm; and
wherein the conversion algorithm is operable to convert an effective road wheel angle from the test simulator that is based on the less than the fixed number of degrees of freedom of the test simulator into a simulated road wheel angle based on the fixed number of degrees of freedom of the vehicle suspension system.

15. The suspension simulation system set forth in claim 14, wherein the conversion algorithm is operable to calculate the effective steer arm length for the test simulator for any position of the vehicle suspension system.

16. The suspension simulation system set forth in claim 15, wherein the vehicle dynamics mathematical model is operable to calculate the simulated kingpin moment as a function of the simulated road wheel angle, based on the fixed number of degrees of freedom of the vehicle suspension system.

17. The suspension simulation system set forth in claim 16, wherein the memory includes a force calculation algorithm stored thereon, and wherein the processor is operable to execute the force calculation algorithm to calculate a tie rod input force for the test simulator from the effective steer arm length and the simulated kingpin moment.

18. The suspension simulation system set forth in claim 14, wherein the wheel end of the test simulator moves with two degrees of freedom, and wherein the two degrees of freedom include axial movement along a Z-axis of a Cartesian coordinate system, and rotation about the Z-axis of the Cartesian coordinate system.

19. The suspension simulation system set forth in claim 18, wherein the test simulator includes a tie rod actuator operable to apply a force along a tie rod axis to the wheel end to rotate the wheel end about the Z-axis, and a jounce actuator operable to apply a force along the Z-axis to move the wheel end axially along the Z-axis.
